(19) United States
(12) Patent Application Publication
(10) Pub. No.: US 2016/0078336 A1
(43) Pub. Date: Mar. 17, 2016

(54) APPARATUS AND METHOD FOR GENERATING IMAGE-INCLUDED TWO DIMENSIONAL CODE

(71) Applicant: DENSO WAVE INCORPORATED, Chita-gun (JP)

(72) Inventor: Widodo ARI, Tokyo (JP)

(21) Appl. No.: 14/780,886

(22) PCT Filed: Mar. 20, 2014
(86) PCT No.: PCT/JP2014/057820

§ 371 Date: Sep. 28, 2015

(30) Foreign Application Priority Data
Mar. 27, 2013 (JP) 2013-065984

(51) Int. Cl. G06K 19/06

(52) U.S. Cl. CPC G06K 19/06112; G06K 19/06037; G06K 19/06075; G06K 19/06103

(57) ABSTRACT

There is provided a two-dimensional code generator that generates an image-included two-dimensional code. The apparatus includes a deficient region determining unit and a code generating unit that produces an image-included two-dimensional code by applying, to a base image, a two-dimensional image in which the deficient region is present and there is no code information in the deficient region.

### CROSS-REFERENCE TO RELATED APPLICATION

This application is based on and claims the benefit of priority from earlier Japanese Patent Application No. 2013-065984 filed Mar. 27, 2013, the description of which is incorporated herein by reference.

### BACKGROUND

1. Technical Field

The present invention relates to an apparatus and a method for generating a two-dimensional code. More specifically, the present invention relates to an apparatus and a method for generating an image-included two-dimensional code by applying a two-dimensional code to a base image.

2. Background Art

In recent years, with the rising popularity of mobile camera phones, two-dimensional codes are often used for purposes such as advertisements and authentication. The two-dimensional code expresses code information by an impersonal two-dimensional image that is unintelligible to the user. Elements of design are not taken into consideration at all in the two-dimensional code.

Therefore, to improve the design of two-dimensional codes, an image-included two-dimensional code has been proposed, as can be seen in JP-A-2009-104451, for example. In the image-included two-dimensional code, an image (such as a logo) that is meaningful to the user is used as a base image. The two-dimension code is then applied to the base image.

### CITATION LIST

### Patent Literature

[PTL 1] JP-A-2009-104451

### TECHNICAL PROBLEM

However, in the conventional image-included two-dimensional code, cells are set on the base image and code information is attached thereto. Therefore, in most cases, the base image is unattractive in appearance. In addition, when the two-dimensional code is applied to the base image, an operator manually sets the contours and features of the logo or image subject (such as the mouth and eyes when the image subject is a face) in the base image. The cost of generating a code increases.

### SUMMARY

Thus it is desired to improve the design of image-included two-dimensional codes and to enable automatic generation of the image-included two-dimensional code.

A first aspect of the present disclosure is a two-dimensional code generator that generates an image-included two-dimensional code. The two-dimensional code generator includes a code information restricted-region determining unit that determines a code information restricted region in a two-dimensional code. The two-dimensional code generator also includes a code generating unit that generates an image-included two-dimensional code by applying, to a base image, a two-dimensional code in which placement of code information in the code information restricted region is restricted.

For example, in the two-dimensional code generator according to the first aspect, the code information restricted-region determining unit may determine the code information restricted region based on the base image.

In addition, for example, in a two-dimensional code generator according to a second aspect, the code information restricted-region determining unit may determine the code information restricted region to be a specific part area including a specific part of an imaging subject in the base image.

Furthermore, the code information restricted-region determining unit may determine the code information restricted region based on designation by a user, when the specific part area is not present in the base image.

In this case, a preferred example is that the code information restricted-region determining unit determines the code information restricted region by combining error correction code regions.

Still further, the code information restricted-region determining unit determines the code information restricted region by deforming a standard region to match the error correction code regions.

In addition, preferably, there can be provided an image processsing unit which processes an original image for generating the base image. By way of example, the image processing unit processes such original image such that the code information restricted region determined based on the base image by the code information restricted-region determining unit does not overlap with a feature pattern in the image-included two-dimensional image.

Another preferred example is that the code information restricted-region determining unit determines the code information restricted region so as not to overlap with a feature pattern in the image-included two-dimensional image.

As another aspect of the present disclosure, a two-dimensional code generating program is provided. Regarding the two-dimensional code generating program, a computer is made to read a program stored in a memory in advance. As a result, the program enables the computer to function as a two-dimensional code generator. The two-dimensional code generator includes a code information restricted-region determining unit that determines a code information restricted region in a two-dimensional code. The two-dimensional code generator also includes a code generating unit that generates an image-included two-dimensional code by applying, to a base image, a two-dimensional code in which placement of code information in the code information restricted region is restricted.

As yet another aspect of the present disclosure, a two-dimensional code generating method for generating an image-included two-dimensional code is provided. The two-dimensional code generating method includes a code information restricted region determining step of determining a code information restricted region in a two-dimensional code. The two-dimensional code generating method also includes a code generating step of generating an image-included two-dimensional code by applying, to a base image, a two-dimensional code in which code information is not provided in the code information restricted region.

### Advantageous Effects of Invention

In the present disclosure, an image-included two-dimensional code is generated by applying, to a base image, a two-dimensional code in which code information is restricted in a code information restricted region. Therefore, an image-included two-dimensional code can be generated without compromising visual information of a specific part of the base image.

### BRIEF DESCRIPTION OF DRAWINGS

In the accompanying drawings:

FIG. 1 is a block diagram functionally showing a configuration of a two-dimensional code generator according to an embodiment of the present invention;

FIG. 2 is a block diagram of an example of a hardware configuration of the two-dimension code generator;

FIG. 3 is a diagram for explaining the detection of a specific part area according to a first embodiment of the present invention;

FIG. 4 is a diagram of a basic structure of a QR code (registered trademark) according to the first embodiment;

FIG. 5 is a flowchart of an overview of a process performed by a deficient region determining unit according to the first embodiment;

FIG. 6 is a diagram for explaining the calculation of the size of a first largest deficiency-allowed region according to the first embodiment;

FIG. 7 is a diagram for explaining the calculation of the size of a second largest deficiency-allowed region according to the first embodiment;

FIG. 8 is a flowchart of an overview of a process performed by an image processing unit according to the first embodiment;

FIG. 9 is a diagram of an example of an image-included two-dimensional code according to the first embodiment;

FIG. 10 is a block diagram of a configuration of a two-dimensional code generator according to a second embodiment of the present invention;

FIG. 11 is a diagram for explaining a variation example of the detection of a specific part according to an embodiment of the present invention;

FIG. 12 is a diagram for explaining a method for determining the specific part (deficient region) in another variation example of the present invention;

FIG. 13A is a diagram of error correction code regions of a two-dimensional code in another variation example according to an embodiment of the present invention;

FIG. 13B is a diagram of an example in which a rectangular deficient region is applied to the two-dimensional code in the variation example above;

FIG. 13C is a diagram of an example in which the rectangular deficient region in the variation example above is deformed;

FIG. 13D is a diagram of another example in which the rectangular deficient region in the variation example above is deformed; and

FIG. 14 is a diagram for explaining another example of a QR code (registered trademark) in another variation example of the present invention.

### DESCRIPTION OF EMBODIMENTS

A two-dimensional code generator according to the embodiments of the present invention will hereinafter be described with reference to the drawings.

The embodiments described hereafter are examples for carrying out the present invention. The present invention is not limited to the specific configurations described below. In carrying out the present invention, a specific configuration can be used as appropriate based on the mode of implementation.

### First Embodiment

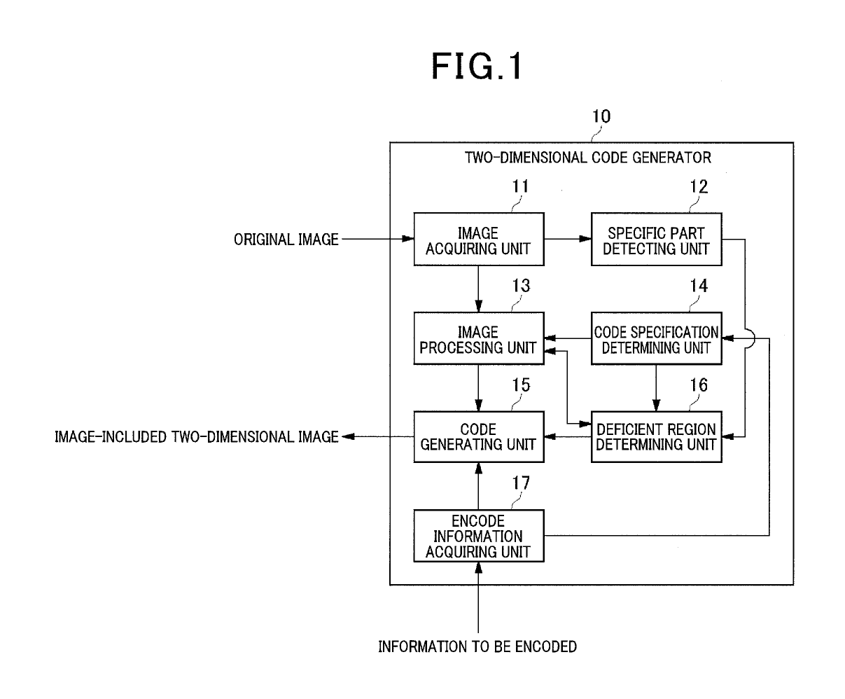

A two-dimensional code generator according to a first embodiment of the present invention will be described with reference to FIG. 1 to FIG. 9.

FIG. 1 shows a configuration of the two-dimensional code generator according to the first embodiment. A two-dimensional code generator 10 according to the present embodiment generates a QR code (registered trademark) as the two-dimensional code. The QR code (registered trademark) is, for example, printed or drawn on the surface of a medium that functions as a code carrier, such as paper or a signboard. The QR code (registered trademark) may also be displayed on a display screen (medium) of a display apparatus. The two-dimensional code is not limited to the QR code (registered trademark). Other two-dimensional codes, such as PDF417 (registered trademark), DataMatrix (registered trademark), or MaxiCode (registered trademark), may also be used.

As shown in FIG. 1, the two-dimensional code generator 10 functionally includes an image acquiring unit 11, a specific part detecting unit 12, an image processing unit 13, a code specification determining unit 14, a code generating unit 15, a deficient region determining unit 16, and an encode information acquiring unit 17. In the present embodiment, the image acquiring unit 11, the specific part detecting unit 12, the code specification determining unit 14, and the deficient region determining unit 16 function as a code information restricted-region determining unit.

The two-dimensional code generator 10 is provided with an input/output interface. The two-dimensional code generator 10 may be functionally realized by a computer running a program. The computer is connected to a communication module, a display apparatus, an input apparatus, and the like. In addition, the two-dimensional code generator 10 may also be similarly functionally realized by a personal computer, or by a tablet terminal or a smartphone. The two-dimensional code generator 10 may also be similarly realized by a portable dedicated apparatus.

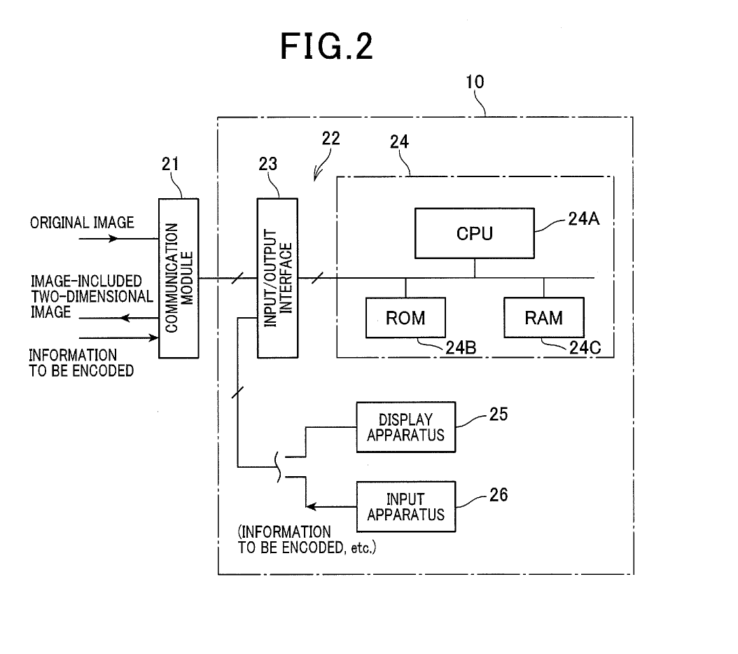

FIG. 2 shows an example in which the two-dimensional code generator 10 is configured by a computer 22. The computer 22 is connected to a communication module 21 that communicates outside the two-dimensional code generator 10. The computer 22 includes an input/output interface 23 that is connected to the communication module 21. The computer 22 also includes a calculating unit 24 that is connected to the input/output interface 23. The calculating unit 24 includes a central processing unit (CPU) 24A, a read-only memory (ROM) 24B, which is a non-transitory computer readable medium, and a random access memory (RAM) 24C. The CPU 24A runs various programs for generating two-dimensional codes. The programs are stored in advance in the ROM 24B. As a result, the calculating unit 24 functionally realizes the above-described image acquiring unit 11, specific part detecting unit 12, image processing unit 13, code specification determining unit 14, code generating unit 15, deficient region determining unit 16, and encode information acquiring unit 17. The RAM 24C can temporarily store therein various pieces of data during two-dimensional code generation. The input/output interface 23 is also connected to a display apparatus 25 and an input apparatus 26.

A method for generating an image-included two-dimensional code, which is a characteristic according to the present embodiment, will hereinafter be described using the above-described configuration of the two-dimensional code generator 10 shown in FIG. 1.

The image acquiring unit 11 acquires an original image in digital format. The original image serves as the source of an image (base image) that serves as the base when the image-included two-dimensional code is generated.

The image acquiring unit 11 may acquire the original image through imaging using an optical module, an image sensor, or the like. Alternatively, the image acquiring unit 11 may acquire the original image by receiving the original image from outside of the two-dimensional code generator 10, via a communication network. The image acquiring unit 11 may also acquire the original image by reading the original image from a storage area of a storage device that provided within or outside the two-dimensional code generator 10. According to the present embodiment, an instance in which a facial image of a person is used as the original image is described. The subject of the original image is not necessarily limited to a facial image of a person. The original image may be any image, such as that of a scenery or a building.

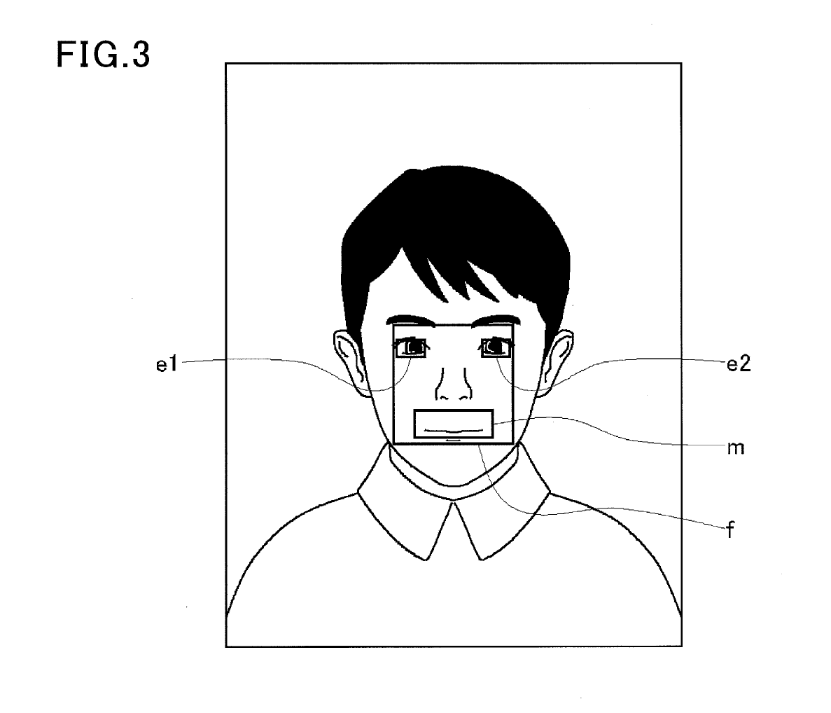

The specific part detecting unit 12 detects an area (specific part area) that includes a specific part of the imaging subject from the original image acquired by the image acquiring unit 11. According to the present embodiment, the specific part detecting unit 12 detects the area of the face (face area) of the person from the original image. FIG. 3 is a diagram for explaining the detection of the specific part area. An existing technique can be used to detect the face area of a person from an image. As shown in FIG. 3, the specific part detecting unit 12 according to the present embodiment detects the eyes e1 and e2, and the mouth m as specific parts. The specific part detecting unit 12 then detects a rectangular area including the detected eyes and mouth as the face area f.

The encode information acquiring unit 17 acquires information to be encoded (encode information) into the two-dimensional code. For example, the information may be inputted by the user using the input apparatus 26. Alternatively, the information may be received from outside the two-dimensional code generator 10, via a communication network. The information to be encoded may be, for example, the contact information (such as an e-mail address) of the person in the original image.

The code specification determining unit 14 determines the specification of the two-dimensional code. The code specification includes version and cell size. The version is determined based on the volume (number of characters) and character type of the information acquired by the encode information acquiring unit 17, and the required error correction level. The cell size is determined based on printing resolution for when the two-dimensional code is printed and reading resolution for when the two-dimensional code is read.

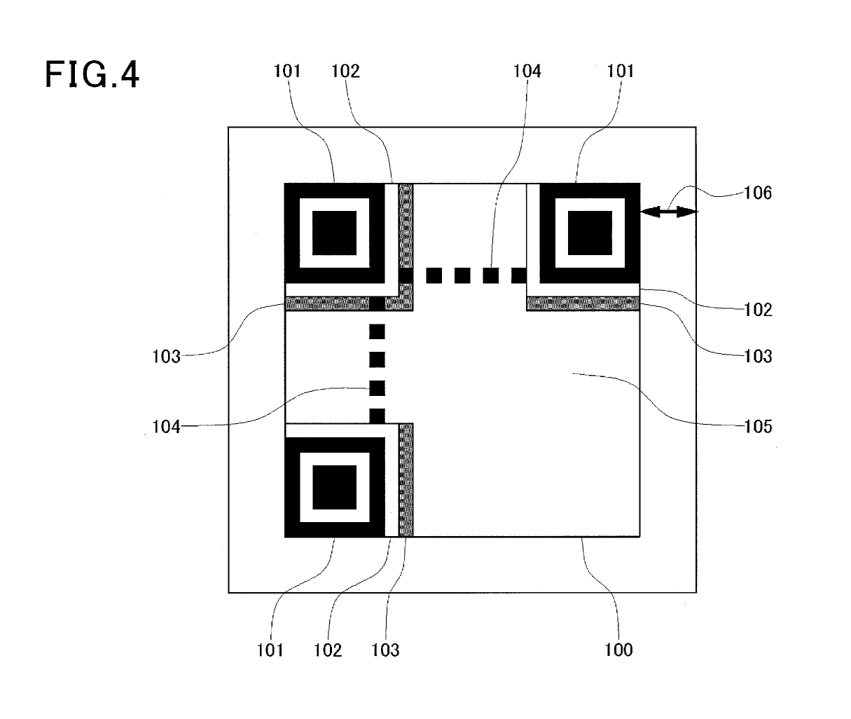

FIG. 4 is a diagram of a basic structure of the QR code (registered trademark). The QR code (registered trademark) 100 is, as a whole, a square-shaped code. Information is expressed using a white or black square cell as the smallest unit. The cells are arranged in a matrix. The QR code (registered trademark) 100 is composed of finder patterns (position detecting patterns) 101, separators 102, format information 103, and a data cell region 105. The data cell region 105 includes a timing pattern 104. In addition, a margin 106 of a predetermined width is secured in the periphery of the QR code (registered trademark) 100.

The finder patterns 101 are patterns or symbols used to detect the position at which the QR code (registered trademark) 100 is clipped from an image (code image) capturing the QR code (registered trademark) 100. The three finder patterns 101 are positioned in three corners (upper left corner, upper right corner, and lower left corner) among the four corners of the QR code (registered trademark) 100, respectively. Two sides of each of the finder patterns 101 serve as the outer edge of the QR code (registered trademark) 100.

The separators 102 are regions provided to clearly separate the finder patterns 101 from information expressed by the cells further inward from the finder patterns 101. Each of the separators 102 is positioned along the two sides of each of the finder patterns 101 that do not serve as the outer edge of the QR code (registered trademark) 100. Each of the separators 102 has a width that amounts to a single cell. The separators 102 are composed of only white cells.

In addition, the format information 103 is provided along the separators 102 on the two inner sides of the finder pattern 101 provided in the upper left corner. The format information 103 is provided along the separator 102 on the lower side of the finder pattern 101 provided in the upper right corner. The format information 103 is provided along the separator 102 on the right side of the finder pattern 101 provided in the lower left corner. The format information 103 includes information on the error correction level to be used and information related to mask pattern, as control information. The format information 103 has a width that amounts to a single cell.

In addition, the timing pattern 104 is provided such as to connect adjacent finder patterns 101. The timing pattern 104 has a width that amounts to a single cell. In the timing pattern 104, white cells and black cells are alternately arranged. The timing pattern 104 used to identify version information.

The area of the QR code (registered trademark) excluding the finder patterns 101, the separators 102, and the format information 103 is the data cell region 105. As described above, the data cell region 105 includes the timing patterns 104. However, the data cell region 105 may also include an alignment pattern.

Returning to FIG. 1, the code specification determining unit 14 determines the version and the cell size based on the acquired information to be encoded. The version reflects the number of cells. The cell size reflects the size of each cell. The code specification determining unit 14 sets a higher version as the volume of the information to be encoded increases or as the error correction level increases. The code specification determining unit 14 sets a larger cell size as the printing resolution and the reading resolution decreases (becomes rougher). Information on the error correction level, the printing resolution, and the reading resolution may be inputted by the user using an input means (not shown) or may be acquired from outside the two-dimensional code generator 10 via a communication network.

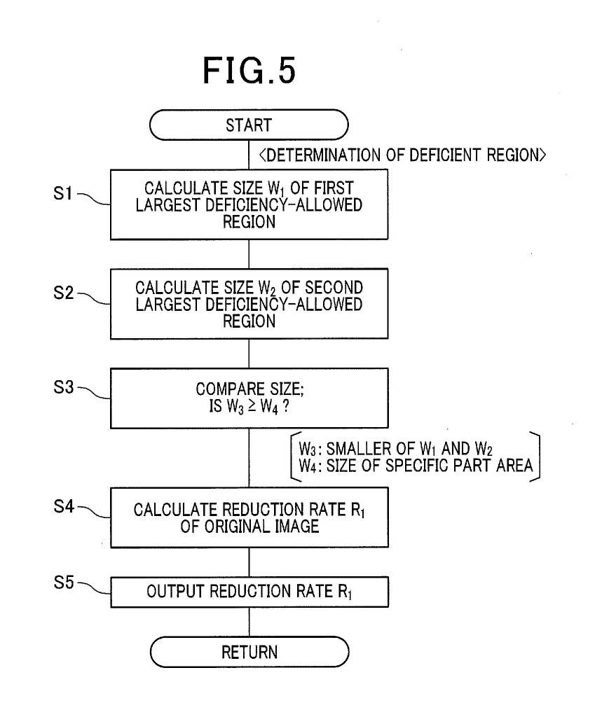

The deficient region determining unit 16 determines a deficient region (that is, a code information restricted region), based on the specific part detected by the specific part detecting unit 12 and the code specification determined by the code specification determining unit 14. Determination of the deficient region will be described with reference to the flowchart in FIG. 5.

First, the deficient region determining unit 16 determines the size W₁ of a rectangular region that is positioned in the center of the QR code (registered trademark) 100 and is the largest region that does not overlap with the finder patterns 101 (first largest deficiency-allowed region) (step S1 in FIG. 5). The finder patterns 101 serve as feature patterns. When the QR code (registered trademark) further includes the alignment pattern as a feature pattern, the largest region that does not overlap with a part of, or the entirety of, the alignment pattern may be considered the first largest deficiency-allowed region. The size W₁ of this region may then be determined. Moreover, the largest region that also does not overlap with other feature patterns, such as the format information 103, may also be set as the first largest deficiency-allowed region.

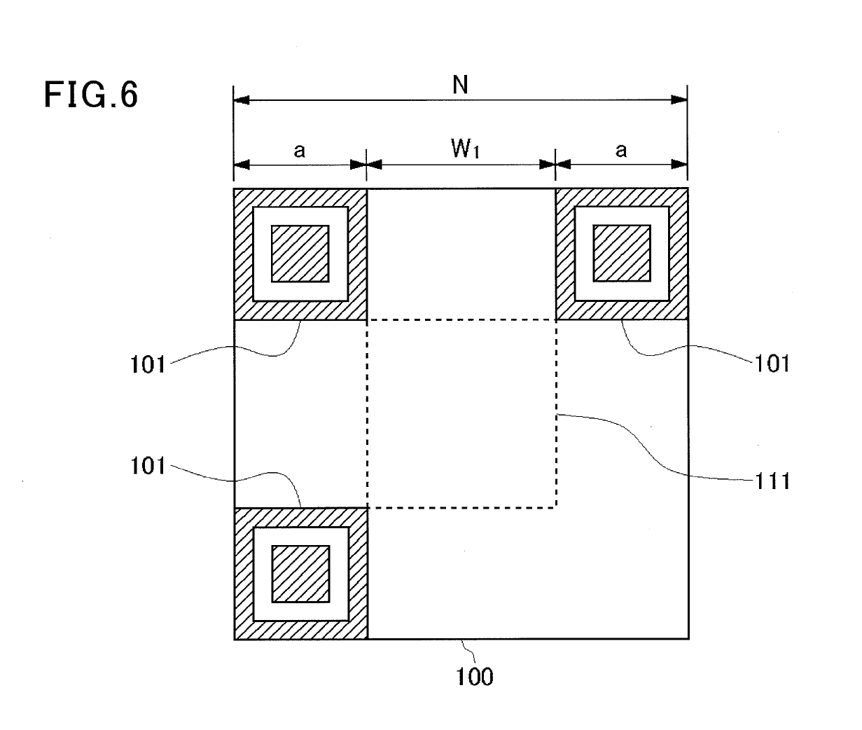

FIG. 6 is a diagram for explaining the calculation of the size of the first largest deficiency-allowed region. Here, for example, in the code specification determined by the code specification determining unit 14, the width of the QR code (registered trademark) 100 is N [cell] and the width of each of the finder patterns is a [cell]. In this case, as shown in FIG. 6, the size W₁ [cell] of a first largest deficiency-allowed region 111 can be determined by expression (1), below.

W₁=N−2×(a+α) (1),

wherein α [cell] is an adjustable parameter. The adjustable parameter α may be zero.

When the widths of the separator 102 and the format information 103 are respectively 1 cell, the width W₁ of the first largest deficiency-allowed region 111 can be determined by expression (1′), below.

W₁=N−2(a+α+2) (1′)

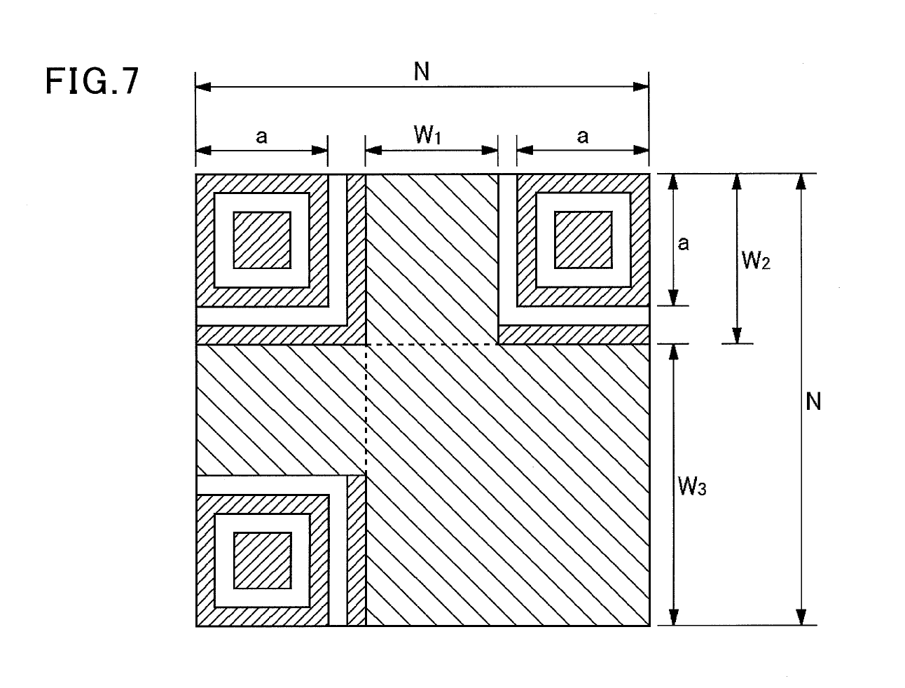

Next, the deficient region determining unit 16 determines the size W₂ of the largest deficiency-allowed region (second largest deficiency-allowed region) based on the error correction level (step S2 in FIG. 5). FIG. 7 is a diagram for explaining the calculation of the size of the second largest deficiency-allowed region. First, the deficient region determining unit 16 determines the area S of the data cell region 105. In FIG. 7, W₁=N−2×a−3, W₂=a+2, and W₃=N−a−2. Therefore, the area of the data cell region 105 can be determined by expression (2), below.

S=W₁×W₂+W₃²=(N−2×a−3)×(a+2)+(N−a−2)² (2)

When the error correction level, that is, the percentage of error allowed is E [%], the width W₂ of the second largest deficiency-allowed region can be determined by expression (3), below.

W₂={S×(E−β)/100}^{1/2} (3)

Here, p [%] is an adjustable parameter. The adjustable parameter β may be zero. The second largest deficiency-allowed region refers to the largest deficient region when error in the data cell region is allowed at a percentage of β/(S−W₂²). Therefore, when the adjustable parameter β is zero, no errors are allowed, aside from the deficient region.

The deficient region determining unit 16 compares size W₃ to the size W₄ of the specific part area (step S3 in FIG. 5). The size W₃ is the size of the smaller of the first largest deficiency-allowed region and the second largest deficiency-allowed region. The specific part area is not necessarily a square. Therefore, the larger of the vertical and lateral dimensions is used as the size W₄. The deficient region determining unit 16 determines a reduction rate R₁ of the original image based on the comparison (step S4 in FIG. 5). Specifically, the deficient region determining unit 16 sets R₁=1 when W₃≧W₄, and R1=W₃/W₄ when W₃<W₄. In other words, the deficient region determining unit 16 determines the reduction rate R₁ of the original image such that the size W₄ of the specific part area is smaller than both the size W₁ of the first largest deficiency-allowed region and the size W₂ of the second largest deficiency-allowed region. The deficient region determining unit 16 outputs the reduction rate R₁ to the image processing unit 13 (step S5 in FIG. 5).

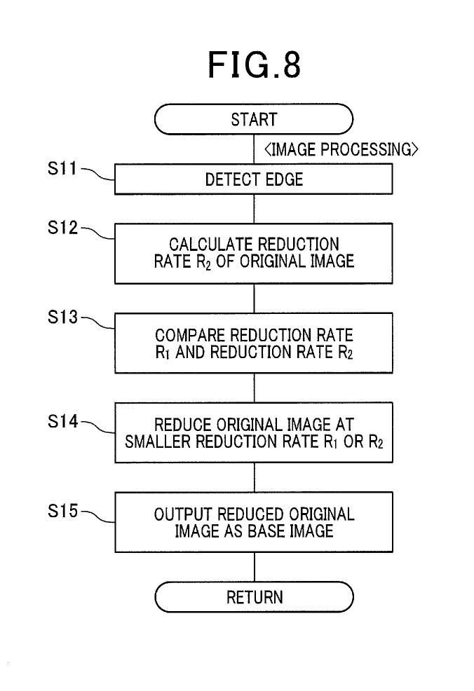

Next, a process performed by the image processing unit 13 will be described with reference to the flowchart in FIG. 8.

The image processing unit 13 detects an edge (a portion in which the difference in pixel value between adjacent pixels is a predetermined threshold or higher) from the original image acquired by the image acquiring unit 11 (step S11 in FIG. 8). Furthermore, the image processing unit 13 determines a reduction rate R₂ at which to reduce the original image such that the detected edge does not overlap with the separators 102, the format information 103, and the timing patterns 104 (step S12 in FIG. 8). When the original image does not need to be reduced, the reduction rate R₂ is set to 1.

The original image is reduced in this way for the following reason. That is, in the image-included two-dimensional code, the two-dimensional code is applied over the base image. Cells that should be expressed by white in ordinary two-dimensional images are colored or set to white based on the base image in the image-included two-dimensional code. Therefore, errors tend to occur at the edge in the base image as a result of such changes. When format information and the like are mapped in an area in which errors tend to occur, the format information cannot be correctly read. Furthermore, the image-included two-dimensional code cannot be interpreted.

Therefore, the image processing unit 13 reduces the original image such that the edge in the image does not overlap with the format information 103 and the like.

The image processing unit 13 further compares the reduction rate R₁ and the reduction rate R₂ (step S13 in FIG. 8). The image processing unit 13 reduces the original image acquired by the image acquiring unit 11 using the smaller of the two reduction rates (step S4 in FIG. 8). The image processing unit 13 then outputs the reduced image to the code generating unit 15 as the base image (step S5 in FIG. 8). In other words, the image processing unit 13 sets all of the specific part areas (the face area in this example) as the deficient region. In addition, the image processing unit 13 determines the deficient region such as to enable clipping of the QR code (registered trademark) using the finder patterns and such that error correction capability is not exceeded. In addition, the deficient region determining unit 16 also reduces the specific part area using the smaller of the reduction rate R₁ and the reduction rate R₂, and outputs the reduced specific part area to the code generating unit 15 as the deficient region.

The code generating unit 15 generates a two-dimensional code in which the information to be encoded acquired by the encoding information acquiring unit 17 is indicated in the data cell region excluding the deficient region. The code generating unit 15 then generates an image-included two-dimensional code by applying the generated two-dimensional code to the base image. An existing technique can be used to generate a two dimensional code that does not have code information in the deficient region. An existing technique (such as the technique in JP-A-2009-104451) can be used to apply the two dimensional code to the base image.

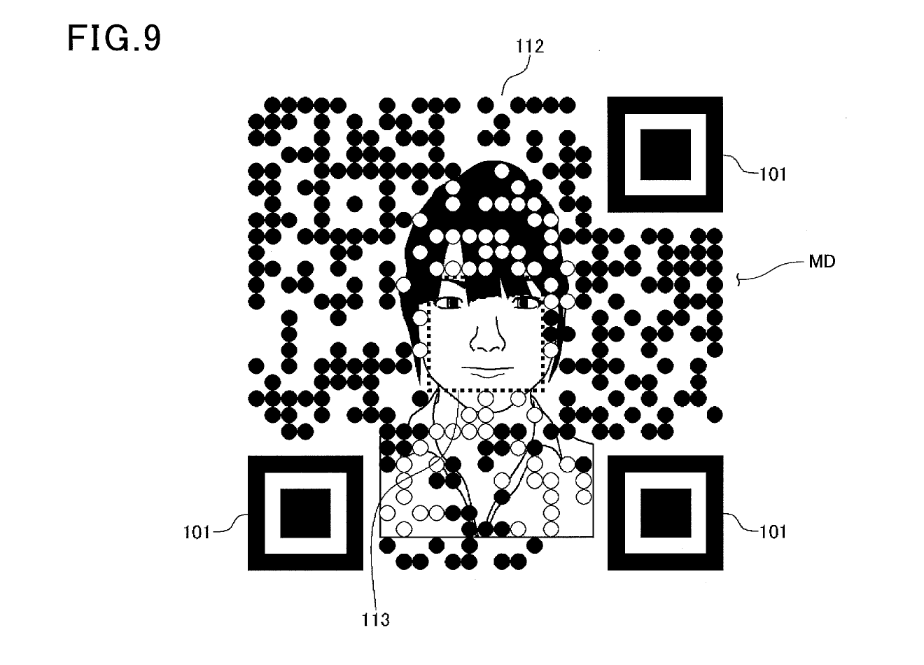

FIG. 9 is a diagram of an example of the image-included two dimensional code generated as described above. In this example, an image of a face of a person is used as the base image. The face area is set as a deficient region 113 (a region that does not have code information). Because code information is not provided in the face portion, the image-included two dimensional code is generated without compromising the visual information of the face. In the image-included two dimensional code 112 in the example in FIG. 9, the finder patterns 101 are respectively set in the upper right corner, the lower left corner, and the lower right corner.

In addition, the finder patterns 101 do not overlap with the deficient region 113. Therefore, a situation in which the QR code (registered trademark) cannot be clipped does not occur. Furthermore, the ratio of the area of the deficient region 113 to the area of the data cell region is the error correction level or lower. Therefore, a situation in which error correction cannot be performed as a result of the deficient region being provided does not occur.

The image-included two-dimensional code 112 generated by the code generating unit 15 is outputted from the two-dimensional code generator 10. The image-included two-dimensional code 112 is printed on a predetermined medium MD, such as paper, by a printing apparatus, such as a printer. Alternatively, the image-included two-dimensional code 112 is displayed by the display apparatus 25. When the display apparatus 25 is used, the display screen thereof also functions as the medium MD.

### Second Embodiment

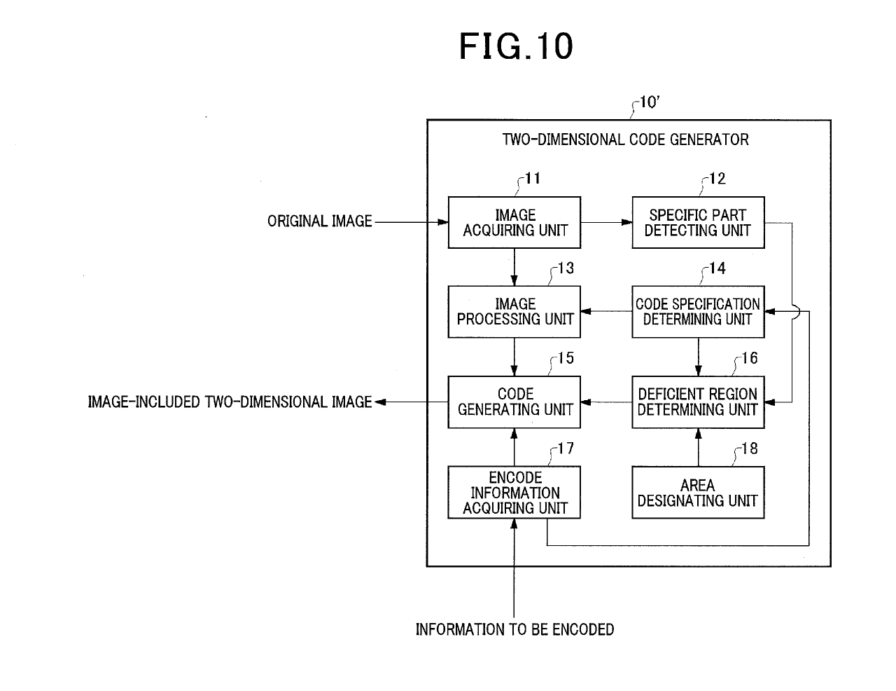

A two-dimensional code generator according to a second embodiment of the present invention will be described with reference to FIG. 10.

FIG. 10 shows a configuration of the two-dimensional code generator according to the second embodiment. In a two-dimensional 10′ according to the second embodiment, configurations that are the same as those of the two-dimensional code generator 10 according to the first embodiment are given the same reference numbers.

Descriptions thereof are omitted. When compared to the two-dimensional code generator 10 according to the first embodiment, the two-dimensional code generator 10′ additionally includes an area designating unit 18.

In the two-dimensional code generator 10′, when the specific part detecting unit 12 is unable to detect an area (specific part area) including the specific part of the imaging subject from the original image acquired by the image acquiring unit 11, the user manually designates the area using the area designating unit 18. The area designating unit 18 includes a touch panel that serves as a display apparatus. When the specific part detecting unit 12 cannot detect the specific part area, a rectangular frame for area designation is displayed in the touch panel. The user makes an input to the touch panel. As a result, the user enlarges, reduces, and moves the frame to designate the area. Information on the designated area is sent from the area designating unit 18 to the deficient region determining unit 16. The deficient region determining unit 16 determines the deficient region based on the rectangular area designated by the area designating unit 18 and the code specification determined by the code specification determining unit 14.

The present embodiment is effective when the original image includes an illustration or characters, such as a logo, rather than a face of a person. In this case, the specific part detecting unit 12 does not detect the specific part area. However, the logo portion can be attached to the two-dimensional code as the deficient region.

### Variation Example

The two-dimensional code generators 10 and 10′ according to the above-described embodiments can be further modified in various ways.

For example, the above-described two-dimensional code generators 10 and 10′ include the image processing unit 13 and the original image is processed. However, the two-dimensional code generator of the present invention is not required to include the image processing unit 13. In this case, the smaller of the first largest deficiency-allowed region and the second largest deficiency-allowed region is determined to be the deficient region 113.

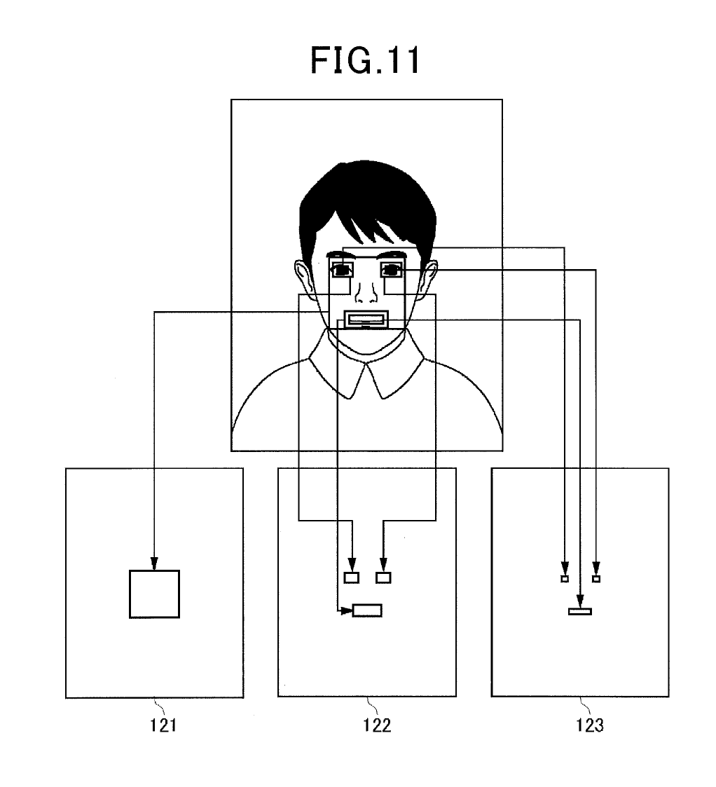

In addition, in the above-described embodiments, the specific part detecting unit 12 detects a rectangular face area from the original image as the specific part area. However, the specific part area is not limited thereto. FIG. 11 shows a variation example of the detection of the specific part area. In FIG. 11, a specific part area 121 is an example in which the face area is set as the specific part area as according to the above-described embodiments. A specific part area 122 is an example in which rectangular template shapes including the eyes and mouth detected from the original image are set as the specific part area. A specific part area 123 is an example in which the areas of the eyes and mouth detected from the original image are set as the specific part area. In this way, deficient regions of various shapes can be determined depending on the various methods for detecting the specific part area. In the examples shown in FIG. 9 and FIG. 11, the specific part area is a rectangle. However, the specific part area is not necessarily required to be a rectangle. For example, as shapes that more strongly emphasize design, a variety of shapes, such as a triangle, a pentagon, and other polygons, a star shape, a diamond shape, or a heart shape, may be used.

In addition, in the above-described embodiments, the two-dimensional code generators 10 and 10′ include the specific part detecting unit 12. The specific part area including the specific part is thereby detected from the original image. However, the two-dimensional code generator of the present invention may not include the specific part detecting unit 12. In this case, when an image of the face of a person is used as the base image, the original image may be acquired in advance such that the eyes, nose, or mouth on the face is included in the deficient region. In this case, when the base image of the face of a person is generated by imaging, the deficient region may be determined from the first largest deficiency-allowed region and the second largest deficiency-allowed region. A frame indicating the deficient region may be displayed in a preview image during imaging.

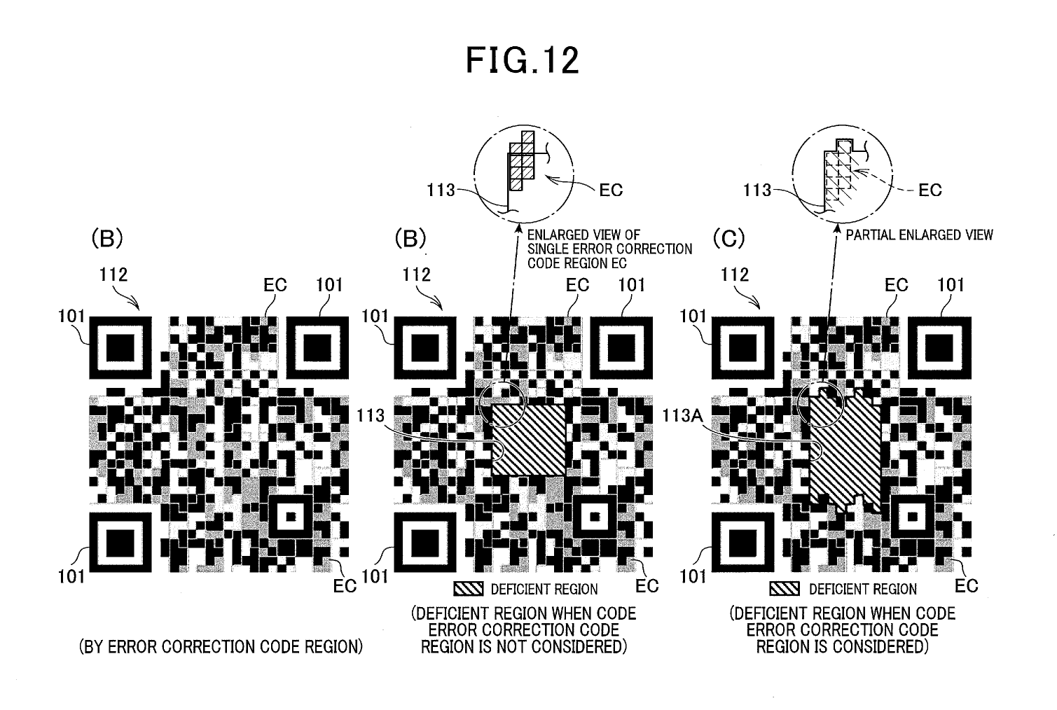

Furthermore, according to the above-described embodiments, the deficient region is a rectangle. The shape of the deficient region is fixed. The deficient region is set to a size that enables error correction based on the error correction level. However, the shape of the deficient region may be determined by changing the basic shape, taking into consideration the error correction capability. This determination will be described with reference to FIG. 12.

FIG. 12 shows the cells configuring the two dimensional code (QR code) 112 by error correction code regions. In this example, the face of a person is determined by manual input. Thereafter, the deficient region 113 is expanded based on error correction code regions EC in the two-dimensional code (QR code). FIG. 12A shows the error correction code regions EC of the QR code 112. In FIG. 12A, each of the plurality of regions surrounded by white lines is an error correction code region EC (code word (eight cells)). Therefore, as shown in FIG. 12B, when the deficient region 113 is determined such that a portion of each of a plurality of error correction code regions EC is included in the deficient region 113, the error correction code region EC having that portion loses error correction capability. Therefore, even when the entirety of each error correction code region EC that has lost error correction capability is determined to be included in the deficient region, code reading performance is unaffected as long as error correction remains within the range of the error correction level set in advance.

Here, the deficient region determining unit 16, that is, the CPU 24A sets the deficient region 113 to a rectangular shape, as shown in FIG. 12B, through interactive operation with the user. Then, the deficient region determining unit 16 checks, by cell units, the extent of overlap between the rectangular region and the plurality of error correction code regions EC positioned in the periphery thereof. Furthermore, the deficient region determining unit 16 sets the entire error correction code region EC as the deficient region, regarding each error correction code region EC that has an overlapping portion. As a result, as shown in FIG. 12C (see enlarged view), for example, regions that partially extend outward from the basic rectangular deficient region 113 are added. A deficient region 113A that, as a whole, has an irregular shape is set. Therefore, code information is not attached to the deficient region 113A. In other words, dots are not provided in the deficient region 113A. Therefore, when the region without dots widens, the rendered portion of the base image also widens. As a result, the intention behind the specific part of the base image becomes clearer, thereby further improving appearance.

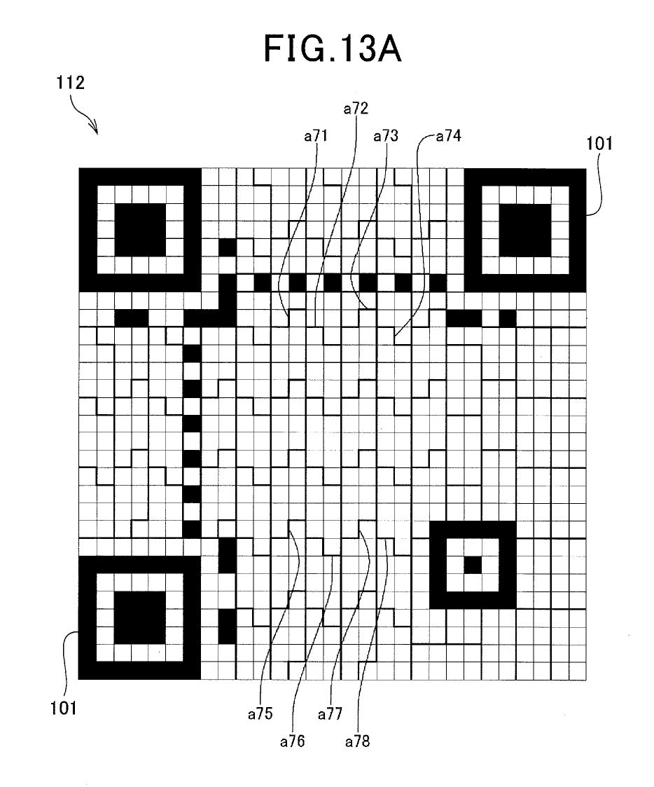

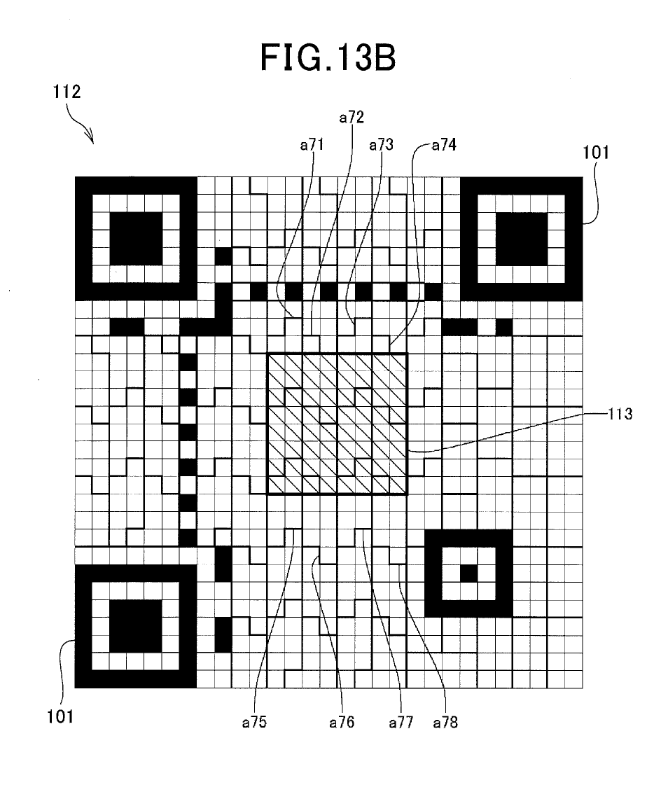

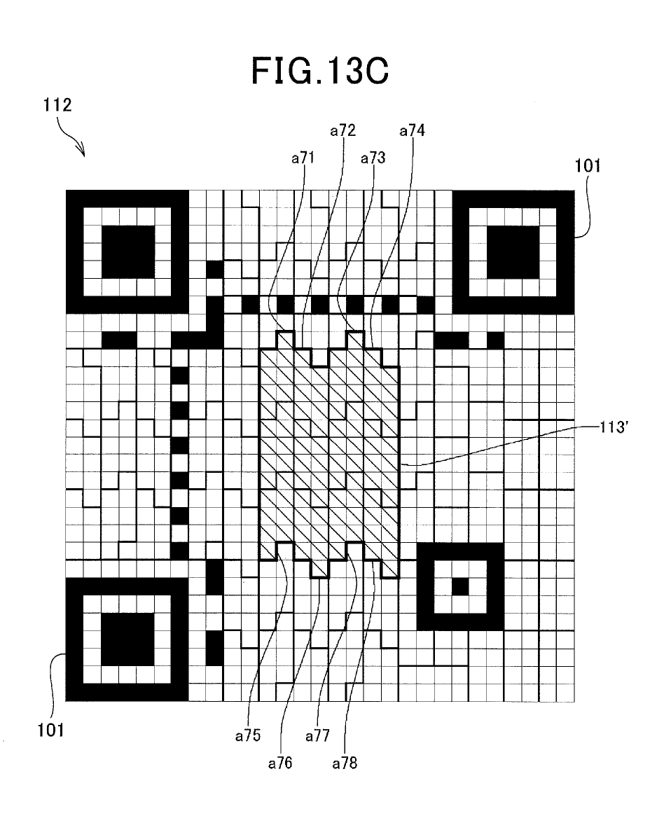

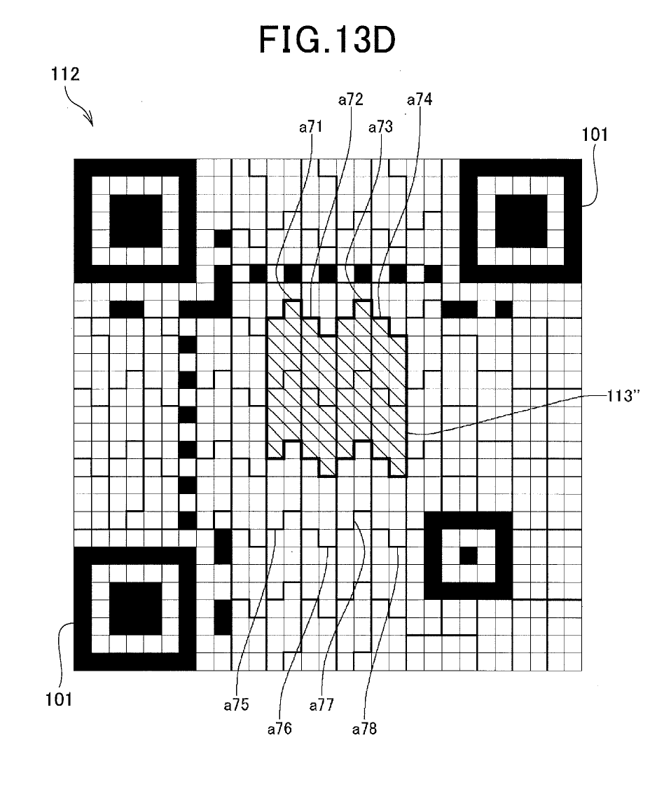

Another example of the above-described method for setting the deficient region based on the error correction code region will be further described with reference to FIG. 13A to FIG. 13D.

FIG. 13A shows the error correction code regions of a two-dimensional code. In FIG. 13A, each error correction code region has a shape surrounded by the thick lines. Error correction is performed using the error correction code region as the unit of error correction. Therefore, when some of the cells in a single error correction code region is set to the deficient region, the error correction code region is unable to perform the error correction function.

FIG. 13B shows an example in which a rectangular deficient region is applied to a two-dimensional code. As shown in FIG. 13B, as a result of the rectangular deficient region 113 being applied, portions of error correction code regions a71 to a81 are set to the deficient region and therefore lose error correction capability. This means that, regarding such error correction code regions a71 to a81, cells that are not set to the deficient region in the rectangular deficient region 113 do not lose error correction capability, even should the cells be set to the deficient region. Therefore, the deficient region determining unit 16 deforms the rectangular deficient region 113 to set such cells to the deficient region, as well.

FIG. 13C shows an example in which the rectangular deficient region 113 is deformed. The deficient region determining unit 16 determines the deficient region by combining the error correction code regions, with the error correction code region as a single unit. Specifically, the deficient region determining unit 16 determines the rectangular deficient region 113 using the above-described method according to the embodiments. Then, the deficient region determining unit 16 deforms the rectangular deficient region 113 such that all cells of the error correction code regions a71 to a81 that have lost error correction capability as a result of the rectangular deficient region 113 are set to the deficient region. The deficient region determining unit 16 sets a region 113′ as the deficient region, as shown in FIG. 13C. Even when the deficient region is enlarged like the region 113′ in FIG. 13C, error correction capability does not decrease, compared to when the deficient region is determined like the region 113 in FIG. 13B. In other words, in the variation example, the deficient region can be enlarged without compromising error correction capability.

When a portion of an error correction code region is set to the deficient region, the error correction code region loses error correction capability. Taking advantage of this feature, error correction capability can also be improved without significantly increasing the size of the deficient region. In this example as well, the deficient region determining unit 16 determines the deficient region by combining the error correction code regions, with the error correction code region as a single unit, in a manner similar to that described above. However, in this example, the rectangular deficient region 113 is applied in a manner similar to that according to the above-described embodiments. Then, regarding an error correction code region of which a predetermined proportion (such as 50%) thereof or more is set to the deficient region, the entire error correction code region is set to the deficient region. When the deficient region in an error correction code region is a predetermined proportion or less, the entire error correction code region is set to a code region, rather than the deficient region.

FIG. 13D is another example in which the rectangular deficient region 113 is deformed. FIG. 13D corresponds to FIG. 13B. As shown in FIG. 13D, an area of 50% or more is set to the deficient region in the error correction code regions a71 to a74, in cases the rectangular deficient region 113 is set as shown in FIG. 13B. Therefore, as shown in FIG. 13D, the rectangular deficient region 113 is deformed such that the entire error correction code region is set to the deficient region, regarding the error correction code regions a71 to a74. Meanwhile, as shown in FIG. 13B, an area of less than 50% is set to the deficient region in the error correction code regions a75 to a78, in cases the rectangular deficient region 113 is set. Therefore, as shown in FIG. 13D, the rectangular deficient region 113 is deformed such that the entire error correction code region is not set to the deficient region, regarding the error correction code regions a75 to a78.

As a result, the deficient region 113 is deformed like the deficient region 113″ in FIG. 13D. In the deficient region 113″, the overall number of cells set to the deficient region does not differ from that of the original rectangular deficient region 113. However, whereas the number of error correction code regions that lose error correction capability is 12 in the rectangular deficient region 113, the number of error correction code regions that lose error correction capability is 8 in the rectangular deficient region 113″. Error correction capability is improved.

Another variation example will be further described. In the two-dimensional code generators 10 and 10′ according to the above-described embodiments, the deficient region in the base image is determined. A two dimensional code that does not have code information in this region is applied to the base image. However, the present invention is not limited thereto. In the two-dimensional code generator of the present invention, a code information restricted region in the base image may be determined. A two-dimensional code in which code information is restricted in this region may be applied to the base image. In other words, the deficient region is an example of the code information restricted region. In addition to the deficient region, the code information restricted region includes, for example, a region in which the cells are smaller than the cells in other regions, a region in which cells having code information are culled, and other regions in which code information is restricted.

As described above, the two-dimensional code generator 10 that generates an image-included two-dimensional code is provided with the deficient region determining unit 16 that determines the deficient region. The two-dimensional code generator 10 is also provided with the code generating unit 15 that generates the image-included two-dimensional code by applying a two-dimensional code that does not have code information in the deficient region to a base image. As a result, in the image-included two-dimensional code 112, code information is not present in the deficient region 113. Therefore, the image-included two-dimensional code 112 can be generated without compromising visual information of the specific part of the base image.

In addition, the deficient region determining unit 16 determines the deficient region 113 based on the base image. Because the deficient region 113 is determined based on the image, manual setting of the deficient region 113 is no longer required. Furthermore, the deficient region determining unit 16 sets an area including a specified part of an imaging subject detected from the base image as the deficient region 113. Conventionally, the image-included two-dimensional image 112 has been generated by the user based on the original image, code information, and the code specification, using experience and intuition. However, as a result of the above-described two-dimensional code generator 10, the image-included two-dimensional code 112 having the deficient region 113 in the specific part area of the image can be automatically generated.

In addition, the above-described two-dimensional code generating unit 10 is provided with the image processing unit 13 that generates the base image by processing the original image. As a result, processing required for the original image can be automatically performed.

In addition, the image processing unit 13 processes the original image such that the deficient region 113 that is determined based on the base image by the deficient region determining unit 16 does not overlap with the finder patterns 101. The finder patterns 101 are set in the corners of a quadrangular two-dimensional code and are used to clip the image-included two dimensional code 112 from a code image capturing the image-included two dimensional code 112. Therefore, a situation in which the finder pattern 101 is set to the deficient region 113 that includes the specific part area, and the image-included two dimensional code 112 cannot be clipped from the code image can be prevented. In addition, the deficient region 113 may be prevented from overlapping with other feature patterns, such as an alignment pattern. As a result, a design that does not interfere with reading can be ensured while taking design into consideration.

In addition, the deficient region determining unit 16 determines the deficient region 113 so as not to overlap with the finder patterns 101. Therefore, a situation in which the finder patterns 101 are set to the deficient region 113 and the image-included two-dimensional code 112 cannot be clipped from the code image can be prevented.

In addition, the deficient region determining unit 16 determines the deficient region 113 to be a center region that does not overlap with the finder patterns 101 and a region that does overlap with the specific part area including the specific part of the imaging subject detected from the base image. Therefore, the image-included two-dimensional code 112 can be generated without compromising the visual information of the specific part of the base image and without disenabling clipping of the image-included two-dimensional code 112 from the code image.

In addition, the deficient region determining unit 16 determines the deficient region 113 based on the error correction level required in the image-included two-dimensional code 112. Therefore, a situation in which error correction cannot be performed as a result of the deficient region being provided can be prevented.

The deficient region determining unit 16 determines the deficient region 113 to be a region in which the second largest deficiency-allowed region and the specific part area including the specific part of the imaging subject detected from the base image overlap. The second largest deficiency-allowed region is the largest deficiency-allowed region based on the error correction level. Therefore, visual information of the specific part of the base image is not compromised. In addition, disenabling of error correction as a result of the deficient region being provided can be prevented.

In addition, the above-described two-dimensional code generator 10 includes the image processing unit 13 that generates the base image by processing the original image. Furthermore, the format information 103 is included in a predetermined position in the two-dimensional code 100. Still further, the image processing unit 13 processes the original image such that an edge in the image does not overlap the position of the format information 103. Therefore, a situation in which an error occurs in the format information 103 as a result of the edge in the image can be prevented.

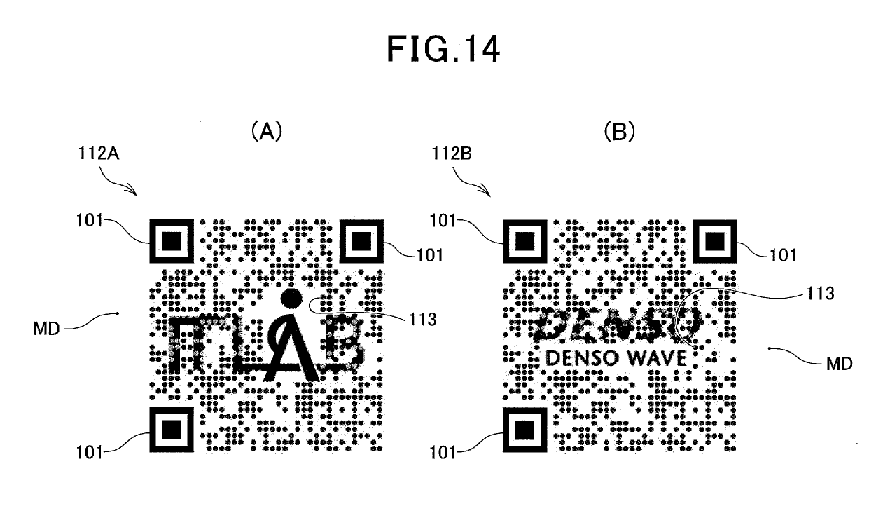

According to the above-described embodiments, examples are described in which the imaging subject in the original image is a face of a person. However, as repeatedly stated, the content of the original image applicable to the present invention is not limited to the face of a person. The imaging subject may be anything, such as a scenery, a building, a painting, an object, a promotional illustration, or a company logo. FIG. 14A and FIG. 14B show examples of image-included QR codes (registered trademark) 112A and 112B in which the code generating method of the present invention is applied to an original image in which a company logo is depicted. In both FIG. 14A and FIG. 14B, depending on the portion of the company logo in which the deficient region 113 is set, the overall company logo can be lightly shown as a background image. A specific part emphasized by the deficient region 113 can be clearly shown and emphasized. As a result, the design thereof can be improved. An image-included QR code (registered trademark) to which required information to be encoded is attached in a manner similar to the above-described content can, of course, also be provided.

### INDUSTRIAL APPLICABILITY

The present invention provides an effect in that an image-included two-dimensional code using a base image can be generated without compromising visual information of a specific part of the base image. For example, the present invention is useful as a two-dimensional code generator that generates an image-included two-dimensional code.

### REFERENCE SIGN LIST

10: two-dimensional code generator
11: image acquiring unit (code information restricted-region determining unit)
12: specific part detecting unit (code information restricted-region determining unit)
13: image processing unit
14: code specification determining unit (code information restricted-region determining unit)
15: code generating unit
16: deficient region determining unit (code information restricted-region determining unit)
17: encode information acquiring unit
100: QR code (registered trademark) (two-dimensional code)
101: finder pattern
102: separator
103: format information
104: timing pattern
105: data cell region
105: margin
111: first largest deficiency-allowed region
112: image-included two-dimensional code
113, 113A, 113′, 113″: deficient region
MD: medium serving as two-dimensional code carrier
EC: error correction code region

1. A two-dimensional code generator, comprising:
a code information restricted-region determining unit that determines a code information restricted region in a two-dimensional code; and
a code generating unit that generates an image-included two-dimensional code by applying, to a base image, a two-dimensional code in which placement of code information in the code information restricted region is restricted.

2. The two-dimensional code generator of claim 1, wherein the code information restricted-region determining unit determines the code information restricted region based on the base image.

3. The two-dimensional code generator of claim 2, wherein the code information restricted-region determining unit determines the code information restricted region to be a specific part area including a specific part of an imaging subject in the base image.

4. The two-dimensional code generator of claim 3, wherein the code information restricted-region determining unit determines the code information restricted region based on user's instructions when the specific part is not present in the base image.

5. The two-dimensional code generator of claim 1, wherein the code information restricted-region determining unit determines the code information restricted region by combining error correction code regions.

6. The two-dimensional code generator of claim 5, wherein the code information restricted-region determining unit determines the code information restricted region by deforming a standard region to match the error correction code regions.

7. The two-dimensional code generator of claim 2, wherein the two-dimensional code generator comprises an image processing unit that generates the base image by processing an original image.

8. The two-dimensional code generator of claim 5, wherein the image processing unit processes the original image such that the code information restricted region determined based on the base image by the code information restricted-region determining unit is avoided from overlapping with a feature pattern in the image-included two-dimensional image.

9. The two-dimensional code generator of claim 1, wherein the code information restricted-region determining unit determines the code information restricted region so as avoid the code information restricted area from overlapping with a feature pattern in the image-included two-dimensional image.

10. The two-dimensional code generator of claim 1, wherein the code information restricted-region determining unit determines, as the code information restricted region, an area which is avoided from overlapping with the feature pattern in the image-included two-dimensional code and an area which overlaps with the specific part area including the specific part of the imaging subject in the base image.

11. The two-dimensional code generator of claim 8, wherein the feature pattern is composed of finder patterns on which the image-included two-dimensional code is clipped from a code image obtained by imaging the image-included two-dimensional code, the finder codes being arranged at corners of the two-dimensional code whose shape is rectangular.

12. The two-dimensional code generator of claim 1, wherein the code information restricted-region determining unit determines the code information restricted region based on a level of error correction required by the image-included two-dimensional code.

13. The two-dimensional code generator of claim 12, wherein the code information restricted-region determining unit determines, as the code information restricted region, a specific area containing a specific part of the imaging subject in the base image, the specific area being not larger in size than a largest restriction-allowable region for the information code.

14. The two-dimensional code generator of claim 12, wherein the two-dimensional code generator comprises an image processing unit that generates the base image by processing an original image,
wherein the two-dimensional code includes control information at a predetermined position in the two-dimensional code, and
the image processing unit processes the original image so as to avoid an edge of the generated base image from overlapping with the predetermined position at which the control information is present in two-dimensional code.

15. A program for producing a two-dimensional code by enabling a computer to read and perform a program previously stored in a memory, which enables the computer to function as a two-dimensional generator which functionally comprises:
a code information restricted-region determining unit that determines a code information restricted region in the two-dimensional code; and
a code generating unit that generates an image-included two-dimensional code by applying, to a base image, a two-dimensional code with no code information in the code information restricted region thereof.

16. A method for producing a two-dimensional code, wherein the method comprises steps of:
a code information restricted-region determining step that determines a code information restricted region in the two-dimensional code; and
a code generating step that generates an image-included two-dimensional code by applying, to a base image, a two-dimensional code with no code information in the code information restricted region thereof.

17. The two-dimensional code generator of claim 2, wherein the code information restricted-region determining unit determines the code information restricted region by combining error correction code regions.

18. The two-dimensional code generator of claim 3, wherein the code information restricted-region determining unit determines the code information restricted region by combining error correction code regions.

19. The two-dimensional code generator of claim 9, wherein the feature pattern is composed of finder patterns on which the image-included two-dimensional code is clipped from a code image obtained by imaging the image-included two-dimensional code, the finder codes being arranged at corners of the two-dimensional code whose shape is rectangular.

20. The two-dimensional code generator of claim 9, wherein the feature pattern is composed of finder patterns on which the image-included two-dimensional code is clipped from a code image obtained by imaging the image-included two-dimensional code, the finder codes being arranged at corners of the two-dimensional code whose shape is rectangular.
